(19) United States
(12) Patent Application Publication
(10) Pub. No.: US 2004/0026573 A1
(43) Pub. Date: Feb. 12, 2004

(54) Method and device at automatic landing

(76) Inventors: Sune Andersson, Angelholm (SE); Lars-Ake Warnstam, Linkoping (SE)

Correspondence Address: MERCHANT & GOULD PC, P.O. BOX 2903, MINNEAPOLIS, MN, 55402-0903, US

(21) Appl. No.: 10/398,730

(22) PCT Filed: Oct. 10, 2001
(86) PCT No.: PCT/SE01/02189

(30) Foreign Application Priority Data
Oct. 13, 2000 (SE) 0003694-7

(51) Int. Cl. G05D 1/12

(52) U.S. Cl. 244/183

(57) ABSTRACT

Method and arrangment in the automatic landing of an aircraft (1), comprising a unit (4) arranged on the aircraft (1) and designed to form an image of a group of radiation sources (3) located next to a runway (2), and a calculation device connected to the imaging unit (4) and designed to continuously calculate the position and orientation of the aircraft (1) in relation to the runway (2) using the image formed by the imaging unit (4), in which the radiation sources (3) are deployed at precisely plotted co-ordinates, which are stored in a memory situated in the calculation device, and in which the said co-ordinates are used in calculating the position and orientation of the aircraft (1) when landing.

The present invention relates to a method according to the pre-characterising clause of claim 1.

The invention also relates to an arrangement according to the pre-characterising clause of claim 4.

In the automatic landing of heavier aircraft with subsequent landing run and braking, it must be possible to determine the position and orientation of the aeroplane precisely to within a few decimetres from a distance of approximately 1200 m from the point of touchdown until the aeroplane has come to a standstill. With present-day automatic landing systems, a Global Position System (GPS) is often used initially before going over to an Instrument Landing System (ILS) for the actual landing. ILS requires expensive and bulky equipment. One alternative that does not rely on GPS and ILS is to use visual landing aids.

Visual landing aids in relation to automatic landing have been disclosed previously by U.S. Pat. No. 5,235,513, in which the six degrees of freedom of the aircraft are calculated by means of three searchlights located in a triangle at one end of the runway. In calculating the degrees of freedom, use is made of a camera mounted on the aircraft, which forms an image of the searchlights. The camera is connected to a computer, which performs the calculations.

U.S. Pat. No. 4,385,354 describes another method relating to the automatic landing of aircraft, in which the aircraft has an infrared sensor, which is adjustable in such a way that its line of sight (centre of the image) is kept in line with the centre radiation source of three infrared radiation sources located in a straight line at one end of a runway. The sensor follows a well-defined scanning procedure in which the position of each image point in the field of view can be identified through an X-Y system of co-ordinates, the values of which can be derived directly from the scanning signals. In this system of co-ordinates with the forward direction of the sensor as origin, the co-ordinates of the three radiation sources can be plotted and stored.

The object of the present invention is partly to improve upon a method according-to the pre-characterising clause of claim 1 and partly to improve upon an arrangement according to the pre-characterising clause of claim 4. This is achieved by the method according to the invention having the characteristic features specified in the characterising part of claim 1. The characteristic features of the arrangement according to the invention are set out in the characterising part of claim 4.

In putting the invention into practice, the method and the arrangement according to the invention have the features specified in the characterising parts of claims 2-3, and claims 5-7 respectively.

The invention will be explained in further detail below with reference to drawings attached, in which

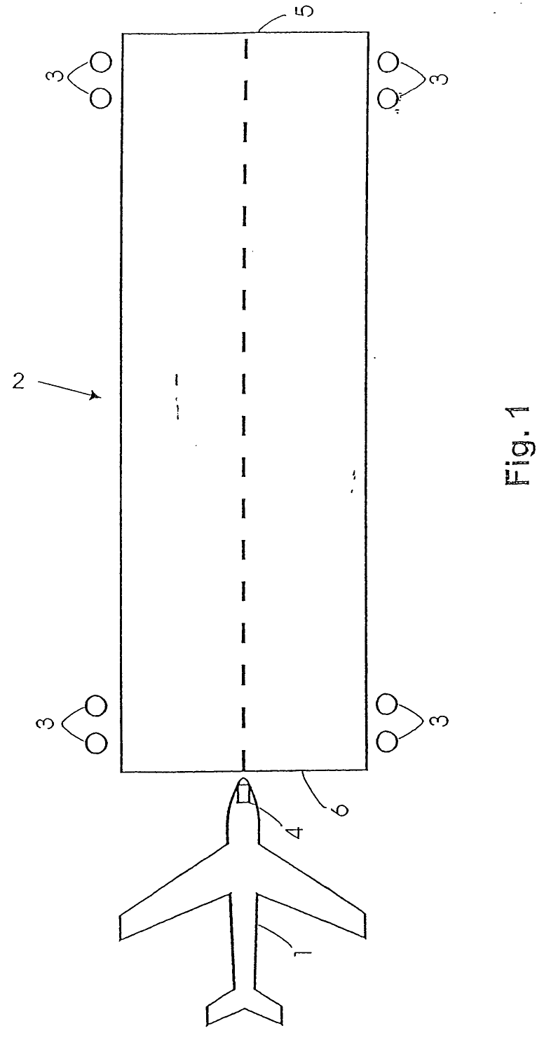

FIG. 1 shows a diagram of an aircraft with a fitted camera and a runway with radiation sources located alongside the runway.

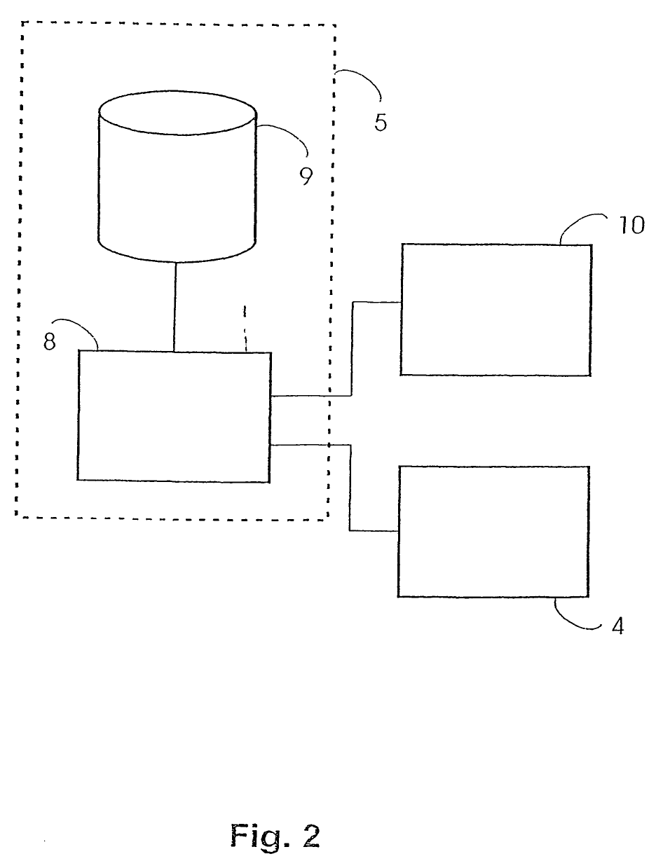

FIG. 2 shows a block diagram, which illustrates the components forming part of the aircraft.

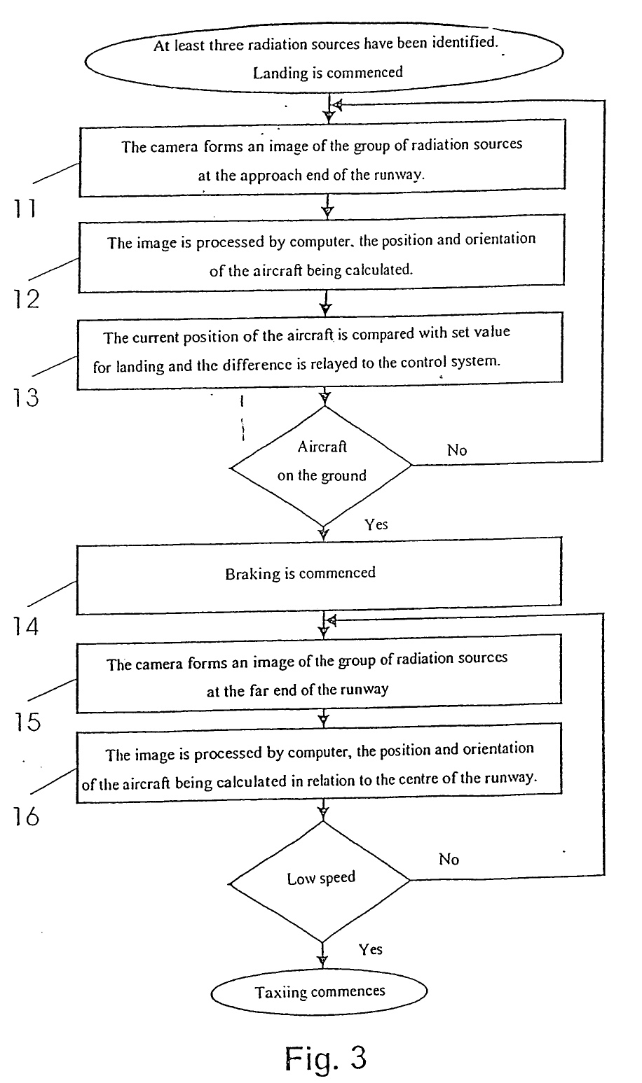

FIG. 3 shows a flow chart, which illustrates the method according to the invention.

In the drawings, 1 denotes an aircraft, such as an aeroplane or a helicopter, for example. Mounted on the aircraft 1 is a camera 4, preferably a video camera, directed forwards, which is designed, during landing, to form an image of groups of radiation sources 3 located next to a runway 2. The video camera 4 may be of any type familiar from image processing systems, such as a CCD camera or a CMOS camera, for example.

A computer 5, see FIG. 2, which comprises an image processing unit 8, which processes the images taken by the camera 4, and a memory 9, is connected to the camera 4. The image-processing unit 8 is connected to the control system 10 of the aircraft 1. Processing an image in order to determine the position and orientation of an aircraft is a technique familiar to the person skilled in the art and will not be further described here, see, for example, SAAB-SCANIA AB's Technical Notes. TN68, published 1972.

The radiation sources 3 are located at precisely plotted positions alongside the runway 2. The co-ordinates of the said positions are given in a local system of co-ordinates with an axis preferably oriented along the centre line of the runway 2. The said co-ordinates are also stored in the memory 9 of the computer 5, so as to be able to continuously calculate the position and orientation of the aircraft 1 in relation to the runway 2. There are at least six radiation sources 3 and these are located in groups of at least three at both ends 6, 7 of the runway. The more radiation sources 3 deployed, the greater the accuracy obtained in the calculation. By using at least four radiation sources 3, the position of the aircraft 1 is calculated by means of two or more possible combinations of radiation sources 3. The said combinations must give the same result for landing to proceed.

Since the positions of the radiation sources 3 on the ground and in relation to one another are stored in the memory of the computer 5, the direction in which radiation sources 3 are to be searched for when landing commences is known. This means that the radiation sources can be rapidly distinguished and identified.

The positions of the radiation sources in relation to one another need not form any special geometric pattern or be in a straight line, but may be set out arbitrarily with precisely specified co-ordinates. The beam angle of the radiation sources 3 is preferably 0°-10° vertically and −10°-+10° laterally.

In order to achieve a high degree of accuracy at the touchdown of the aircraft 1, groups of radiation sources 3 are used at the approach end 6 of the runway 2. After landing, the group of radiation sources 3 at the far end 7 of the runway 2 is used as an aid during the process of braking the aircraft 1. A nominal guide value for landing is lateral projection of the centre line of the runway and a 3-degree gliding angle with base at the planned point of touchdown.

The radiation sources 3 may be either lamps of conventional type or IR sources. If IR sources are used, the camera 4 must be IR-sensitive.

In a preferred embodiment of the invention (shown in FIG. 3), automatic landing of an aircraft 1 is performed according to the following method:

1. The aircraft 1 has a navigation accuracy sufficient for gliding to approximately 60 m, where radiation sources 3 can be distinguished and identified. When at least three radiation sources 3 have been identified, landing is commenced. The camera 4 forms an image of the group of radiation sources 3 at the approach end of the runway 6 (stage 11).

2. The image is processed in the image-processing unit 8 of the computer 5, the position and orientation of the aircraft 1 in relation to the runway 2 being calculated continuously (stage 12). The current position of the aircraft is compared with a set value for landing stored in the memory 9 and the difference relayed to the control system 10 (stage 13).

3. Stages 11 to 13 are repeated until the aircraft 1 has landed and braking has commenced (stage 14). On landing, the landing gear of the aircraft 1 is compressed, which indicates that the aircraft 1 is on the ground. After touchdown, the reduction of speed is commenced through the activation of “spoilers” or through braking and/or thrust reversal.

4. After landing, the camera 4 instead forms an image of the group of radiation sources 3 located at the far end 7 of the runway 2 (stage 15).

5. The image is processed by the image-processing unit 8 of the computer 5, the position and orientation of the aircraft being calculated in relation to the centre of the runway 2 (stage 16). When the aircraft 1 has been slowed to a low speed, taxiing commences. The transition from braking to taxiing is dependent upon the radius of curvature of the exit.

In the case of large runways it is possible to use the existing landing lights, which extend along the runway. There is therefore no need to deploy special radiation sources next to such runways. In the case of runways that do not already have landing lights, such as military runways, for example, it is, however, necessary to set out specific radiation sources beforehand if the method according to the invention is to be applied.

In manned aircraft, the method according to the invention is also used as an aid to decision-making for pilots in manual landing.

1. Method in the automatic landing of an aircraft (1), the position and orientation of the aircraft (1) in relation to a runway (2) being calculated using a first group of radiation sources (3), which are located next to the runway (2) and of which an image is continuously formed, characterised in that the radiation sources (3) are deployed at precisely plotted co-ordinates, which are stored in the aircraft (1) and used in calculating the position and orientation when landing.

2. Method according to claim 1, characterised in that after landing a second group of radiation sources (3) located next to the runway (2) is used as a basis for calculation during a braking process.

3. Method according to claim 1 or 2, characterised in that each group comprises at least three radiation sources (3).

4. Arrangement in the automatic landing of an aircraft (1) according to claim 1, comprising a unit (4) arranged on the aircraft (1) and designed to form an image of a first group of radiation sources (3) located next to a runway (2), and a calculation device (5) connected to the imaging unit (4) and designed to continuously calculate the position and orientation of the aircraft (1) in relation to the runway (2) using the image formed by the imaging unit (4), characterised in that the radiation sources (3) are deployed at precisely plotted co-ordinates, which are stored in a memory (9) situated in the calculation device (5), and in that the said co-ordinates are used in calculating the position and orientation of the aircraft (1) when landing.

5. Arrangement according to claim 4, characterised in that a second group of radiation sources (3) is located next to the runway, which sources are used as a basis for calculation during a braking process after landing.

6. Arrangement according to claim 4 or 5, characterised in that each group comprises at least three radiation sources (3).

7. Arrangement according to claim 6, characterised in that the first group of radiation sources (3) is located at the approach end (6) of the runway (2) and that the second group of radiation sources (3) is located at the far end (7) of the runway (2).

8. Method in the automatic landing of an aircraft consisting of:
the continuous imaging of a first group of radiation sources deployed at precisely plotted co-ordinates next to a runway that are stored in the aircraft:
the calculation of the position and orientation of the aircraft in relation to the runway using the image and the co-ordinates stored in the aircraft.

9. Arrangement in the automatic landing of an aircraft comprising:
a unit arranged on the aircraft and designed to form an image of a first group of radiation sources deployed at precisely plotted co-ordinates next to a runway:
a calculation device connected to the imaging unit and designed to continuously calculate the position and orientation of the aircraft in relation to the runway using the image formed by the imaging unit and the plotted co-ordinates:
a memory situated in the calculation device and in which the plotted co-ordinates are stored.
